(19) United States
(12) Patent Application Publication
(10) Pub. No.: US 2012/0196582 A1
(43) Pub. Date: Aug. 2, 2012

(54) METHOD AND APPARATUS FOR CONFIGURING CALLER IDENTIFICATION MULTIMEDIA CONTENTS

(75) Inventors: Pius Ahn, Seoul (KR); In Hwan Hwang, Incheon (KR)

(73) Assignee: ID MEDIA CO., LTD, Seoul (KR)

(21) Appl. No.: 13/498,586

(22) PCT Filed: Nov. 23, 2009
(86) PCT No.: PCT/KR2009/006892

§ 371 Date: Mar. 28, 2012

(30) Foreign Application Priority Data
Oct. 1, 2009 (KR) 10-2009-0094057

(51) Int. Cl. H04W 4/16

(52) U.S. Cl. 455/415

(57) ABSTRACT

A method and apparatus for configuring caller identification multimedia contents, in which a caller identification multimedia contents providing server is requested to search for the caller identification multimedia contents. The caller identification multimedia contents providing server is requested to select a callee device which is to receive the caller identification multimedia contents. The caller identification multimedia contents providing server is requested to transmit the caller identification multimedia contents to the callee device.

### TECHNICAL FIELD

The present invention relates to a method and apparatus for configuring caller identification multimedia contents, and more particularly, to a method and apparatus for configuring caller identification multimedia contents in a callee device (e.g. a callee mobile phone) by using an application for providing a caller identification multimedia contents configuring service.

### BACKGROUND ART

A currently-used caller identification service displays caller information in the form of text on the telephone of a callee so that the callee identifies a caller. The caller information includes the telephone number of the caller, the caller's name designated by the callee, and other information pieces. The caller identification service is used to simply check a caller through a text in the form in which the caller's information is displayed on a callee's mobile phone. The caller identification service is free or charged according to mobile radio communication providers.

A mobile phone ring tone service is provided by mobile phone manufacturers, contents providers, and a third party. In more detail, a mobile phone owner may use basic ring tones that have been stored in their mobile phone when the mobile phone was manufactured by a mobile phone manufacturer. The mobile phone owner may also use various ring tones that are downloaded to their mobile phone with or without charge from contents providers that provide a ring tone service. The mobile phone owner may also use ring tones that are received without charge that is paid by a third party.

The mobile phone owner may group phone numbers stored in their mobile phone according to family, friends, co-workers, or the like, and manually designate a ring tone to indicate each group or manually designate a ring tone to indicate each person. Therefore, when their mobile phone receives an incoming call from a caller, a ring tone designated for the caller may ring, and thus the mobile phone owner may identify the caller of the incoming call.

In addition to the mobile phone ring tone service, a photo or moving picture transmission service, a digital image transmission service for providing digital images, such as avatars and phone screen wall-papers, and the like are provided separately from the caller identification service.

### DISCLOSURE OF INVENTION

### Solution to Problem

The present invention provides a method and apparatus for configuring caller identification multimedia contents, in which the caller identification multimedia contents are previously stored in a callee device, an application for providing a caller identification multimedia contents configuring service is activated when caller identification is requested, and thus the previously stored caller identification multimedia contents are reproduced in the callee device, and a computer readable recording medium having recorded thereon a program for executing the method.

### Advantageous Effects of Invention

According to an embodiment of the present invention, a caller may achieve caller identification by displaying multimedia contents having a caller-desired format on the callee devices 171 through 173, and a callee may receive multimedia contents without paying extra charges other than a communication fee and may use a caller identification service by only accepting the reception of the multimedia contents without needing to separately set the mobile phone of the callee.

According to an embodiment of the present invention, a caller may perform caller identification based on identical multimedia contents on behalf of a plurality of callees, whereby a personalized advertisement service may be provided. In addition, according to an embodiment of the present invention, the mobile contents industry for manufacturing and distributing caller identification multimedia contents may be developed.

### BRIEF DESCRIPTION OF DRAWINGS

The above and other features and advantages of the present invention will become more apparent by describing in detail exemplary embodiments thereof with reference to the attached drawings in which:

FIG. 1 is a schematic diagram for explaining a method of configuring caller identification multimedia contents, according to an embodiment of the present invention;

FIG. 2 illustrates a method of transmitting caller identification multimedia contents to a callee device, according to an embodiment of the present invention;

FIG. 3 illustrates a method of configuring caller identification multimedia contents in a callee device, according to an embodiment of the present invention;

FIG. 4 illustrates a method of configuring caller identification multimedia contents in a callee device, according to another embodiment of the present invention;

FIG. 5 is a diagram of a caller device according to an embodiment of the present invention;

FIG. 6 is a diagram of a caller identification multimedia contents providing server according to an embodiment of the present invention;

FIG. 7 is a diagram of a communication service providing server according to an embodiment of the present invention; and

FIG. 8 is a diagram of a callee device according to an embodiment of the present invention.

### BEST MODE FOR CARRYING OUT THE INVENTION

According to an aspect of the present invention, there is provided a method performed in a caller device to configure caller identification multimedia contents, the method including requesting a caller identification multimedia contents providing server to search for the caller identification multimedia contents; requesting the caller identification multimedia contents providing server to select a callee device which is to receive the caller identification multimedia contents; and requesting the caller identification multimedia contents providing server to transmit the caller identification multimedia contents to the callee device.

According to an embodiment of the present invention, the search requesting, the selection requesting, and the multimedia contents transmission requesting are performed using an application for providing a caller identification multimedia contents configuring service.

According to an embodiment of the present invention, the application is downloaded from the caller identification multimedia contents providing server or implemented into software embedded in the caller device.

According to an embodiment of the present invention, the search requesting, the selection requesting, and the multimedia contents transmission requesting are performed using a Wireless Application Protocol (WAP) interface or a World Wide Web (WWW) interface which are implemented in the caller identification multimedia contents providing server.

According to an embodiment of the present invention, the method further includes selecting the callee device which is to be requested for a caller identification connection; and requesting the caller identification multimedia contents providing server so that the callee device stands by the caller identification connection.

According to an embodiment of the present invention, the method further includes receiving a caller identification connection standby response from the caller identification multimedia contents providing server, wherein the caller identification connection standby response indicates that the caller identification multimedia contents have been configured in the callee device and the application has been activated; and requesting the caller identification multimedia contents providing server for the caller identification connection.

According to another aspect of the present invention, there is provided a method performed in a caller identification multimedia contents providing server to configure caller identification multimedia contents, the method including searching for the caller identification multimedia contents from a predetermined multimedia contents database at a request of a caller device; selecting a callee device which is to receive the caller identification multimedia contents; requesting the callee device to receive the caller identification multimedia contents; and if the callee device accepts the request to receive the caller identification multimedia contents, transmitting the caller identification multimedia contents to the callee device.

According to an embodiment of the present invention, the predetermined multimedia contents database is configured of a record including caller names, the number of the caller device, multimedia contents types, respective index values corresponding to the multimedia contents types, respective multimedia contents names corresponding to the multimedia contents types, respective file names corresponding to the multimedia contents types, and respective file sizes corresponding to the multimedia contents types.

According to an embodiment of the present invention, the record is implemented in the format of an electronic business card based on a vCard or wCard standard.

According to an embodiment of the present invention, the method further includes receiving a caller identification connection standby request for the callee device from the caller device; searching for the caller identification multimedia contents corresponding to the caller device from the predetermined multimedia contents database; and generating an activation message including an identifier (ID) of the caller identification multimedia contents and an ID of an application for providing a caller identification multimedia contents configuring service.

According to an embodiment of the present invention, the method further includes requesting a communication service providing server to transmit the activation message to the callee device.

According to another aspect of the present invention, there is provided a method performed in a communication service providing server to configure caller identification multimedia contents, the method including transmitting an activation message including an ID of the caller identification multimedia contents and an ID of an application for providing a caller identification multimedia contents configuring service to a callee device; receiving a caller identification connection standby response from the callee device, wherein the caller identification connection standby response indicates that the caller identification multimedia contents have been configured in the callee device and the application has been activated; and requesting the callee device for a caller identification connection.

According to another aspect of the present invention, there is provided a method performed in a callee device to configure caller identification multimedia contents, the method including receiving a caller identification multimedia contents reception request from a caller identification multimedia contents providing server; if the callee device accepts the caller identification multimedia contents reception request, receiving the caller identification multimedia contents from the caller identification multimedia contents providing server; and if the callee device refuses the request to receive the caller identification multimedia contents, notifying the caller identification multimedia contents providing server of the refusal to receive the caller identification multimedia contents.

According to an embodiment of the present invention, the method further includes receiving an activation message including an ID of the caller identification multimedia contents and an ID of an application for providing a caller identification multimedia contents configuring service from a communication service providing server; activating the application; setting the caller identification multimedia contents to be a basic ring tone; transmitting a caller identification connection standby response to the communication service providing server, wherein the caller identification connection standby response indicates the state that the activating and the basic ring tone setting were properly performed; and if the caller identification connection request is received from the communication service providing server, reproducing the caller identification multimedia contents.

According to an embodiment of the present invention, the method further includes backing up an original basic ring tone; and restoring the original basic ring tone when the caller identification connection is concluded.

According to another aspect of the present invention, there is provided a computer readable recording medium having recorded thereon a program for executing the method of configuring caller identification multimedia contents.

According to another aspect of the present invention, there is provided a caller device including a multimedia contents search request unit requesting a caller identification multimedia contents providing server to search for the caller identification multimedia contents; a multimedia contents callee selection request unit requesting the caller identification multimedia contents providing server to select a callee device which is to receive the caller identification multimedia contents; and a multimedia contents transmission request unit requesting the caller identification multimedia contents providing server to transmit the caller identification multimedia contents to the callee device.

According to another aspect of the present invention, there is provided a caller identification multimedia contents providing server including a multimedia contents search unit searching for the caller identification multimedia contents from a predetermined multimedia contents database at a request of a caller device; a multimedia contents callee selection unit selecting a callee device which is to receive the caller identification multimedia contents; a multimedia contents reception request unit requesting the callee device to receive the caller identification multimedia contents; and a multimedia contents transmission unit, if the callee device accepts the request to receive the caller identification multimedia contents, transmitting the caller identification multimedia contents to the callee device.

According to another aspect of the present invention, there is provided a communication service providing server including an activation message transmission unit transmitting an activation message including an ID of the caller identification multimedia contents and an ID of an application for providing a caller identification multimedia contents configuring service to a callee device; a caller identification connection standby receiving unit receiving a caller identification connection standby response from the callee device, wherein the caller identification connection standby response indicates that the caller identification multimedia contents have been configured in the callee device and the application has been activated; and a caller identification connection request unit requesting the callee device for a caller identification connection.

According to another aspect of the present invention, there is provided a callee device including a multimedia contents reception request receiving unit receiving a caller identification multimedia contents reception request from a caller identification multimedia contents providing server; a multimedia contents receiving unit, if the callee device accepts the caller identification multimedia contents reception request, receiving the caller identification multimedia contents from the caller identification multimedia contents providing server; and a multimedia contents reception refusal notifying unit, if the callee device refuses the request to receive the caller identification multimedia contents, notifying the caller identification multimedia contents providing server of the refusal to receive the caller identification multimedia contents.

### Mode for the Invention

The present invention will now be described more fully with reference to the accompanying drawings, in which exemplary embodiments of the invention are shown. In the drawings, the thicknesses of layers and regions are exaggerated for clarity. Like reference numerals in the drawings denote like elements.

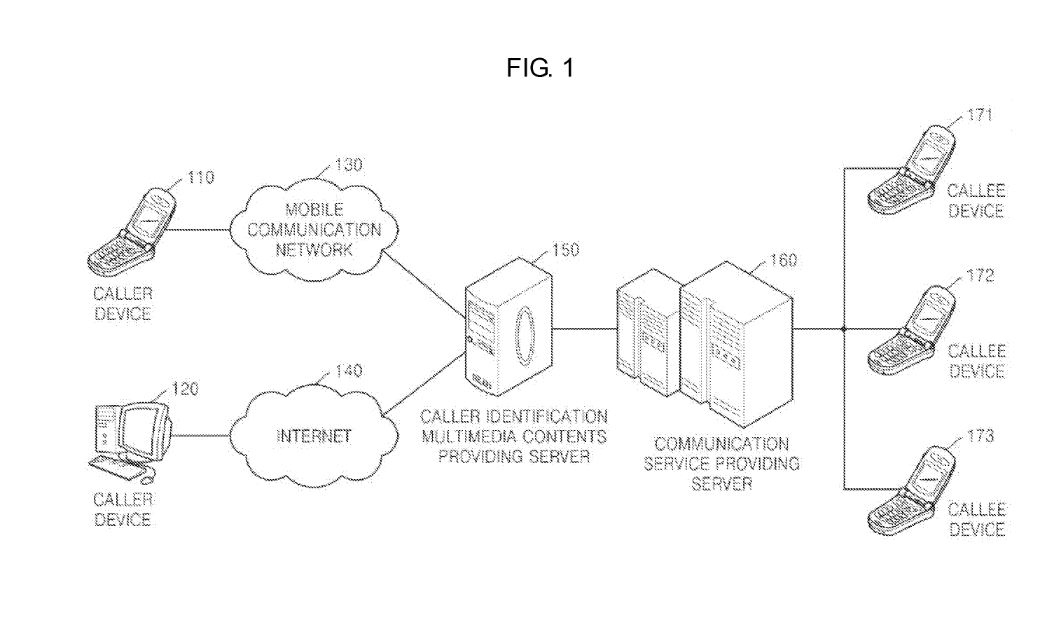

FIG. 1 is a schematic diagram for explaining a method of configuring caller identification multimedia contents, according to an embodiment of the present invention.

Referring to FIG. 1, to explain the method of configuring caller identification multimedia contents according to the present embodiment, caller devices 110 and 120 including a caller mobile phone and a caller client PC, respectively, a caller identification multimedia contents providing server 150 for providing a caller identification multimedia contents configuring service via a mobile communication network 130 or the Internet 140, a communication service providing server 160 for transmitting caller identification connection and an activation message, and callee devices 171 through 173 including callee mobile phones, respectively, are defined according to an embodiment of the present invention.

The method of configuring caller identification multimedia contents according to the present embodiment is roughly divided into two paths. In the first path, caller identification multimedia contents are provided to the callee devices 171 through 173 by mutual operations between the caller devices 110 and 120, the caller identification multimedia contents providing server 150, and the callee devices 171 through 173.

The caller devices 110 and 120 may be connected to the caller identification multimedia contents providing server 150 by using a dedicated application, a Wireless Application Protocol (WAP) interface, a World Wide Web (WWW) interface, or any other communication protocol.

According to the present embodiment, the caller devices 110 and 120 are connected to the caller identification multimedia contents providing server 150 through the dedicated application, the WAP interface, the WWW interface, or any other communication protocol. However, the caller devices 110 and 120 may be connected to the caller identification multimedia contents providing server 150 according to other methods.

The callee devices 171 through 173 may receive the caller identification multimedia contents from the caller identification multimedia contents providing server 150 by using a callback Uniform Resource Locator (URL) included in a Short Message Service (SMS) message or a dedicated application identified by an application identifier (ID) included in a WAP PUSH message.

Although it is stated that the callee devices 171 through 173 may use a callback URL received in a general SMS transmission method or an application identified in a WAP PUSH method in order to receive the caller identification multimedia contents from the caller identification multimedia contents providing server 150, the callee devices 171 through 173 may use other receiving methods or other receiving protocols.

In the second path, the callee devices 171 through 173 are requested for a caller identification connection standby by mutual operations between the caller devices 110 and 120, the caller identification multimedia contents providing server 150, the communication service providing server 160, and the callee devices 171 through 173, and the callee devices 171 through 173 automatically configure the caller identification multimedia contents and then reproduce the caller identification multimedia contents.

A caller identification connection includes call connection, notification, alarm, and so on. In other words, the caller identification connection includes all possible caller identification connections from the caller devices 110 and 120 to the callee devices 171 through 173.

The caller identification multimedia contents providing server 150 transmits an ID of an application for providing a caller identification multimedia contents configuring service, which is installed in the callee devices 171 through 173, to the communication service providing server 160 in order to activate the application. The caller identification multimedia contents providing server 150 also transmits an ID of the caller identification multimedia contents to the communication service providing server 160 so that the ID of the caller identification multimedia contents is transmitted to the callee devices 171 through 173.

The communication service providing server 160 transmits an activation message including the application ID, which is used to activate the application installed in the callee devices 171 through 173, and the caller identification multimedia contents ID to the callee devices 171 through 173. The communication service providing server 160 may use the WAP PUSH method including an application ID or the general SMS transmission method including a callback URL in order to transmit the activation message. However, other activation message transmitting methods may be used.

The communication service providing server 160 may attempt the caller identification connection in a caller identification connection standby state.

According to the present embodiment, the caller identification multimedia contents providing server 150 and the communication service providing server 160 are separated from each other and perform separate functions. However, the two servers may be integrally formed in one unit and may be operated by an identical service provider.

According to an embodiment of the present invention, a caller may achieve caller identification by displaying multimedia contents having a caller-desired format on the callee devices 171 through 173, and a callee may receive multimedia contents without paying extra charges other than a communication fee and may use a caller identification service by only accepting the reception of the multimedia contents without needing to separately set the mobile phone of the callee.

According to an embodiment of the present invention, a caller may perform caller identification based on identical multimedia contents on behalf of a plurality of callees, whereby a personalized advertisement service may be provided. In addition, according to an embodiment of the present invention, the mobile contents industry for manufacturing and distributing caller identification multimedia contents may be developed.

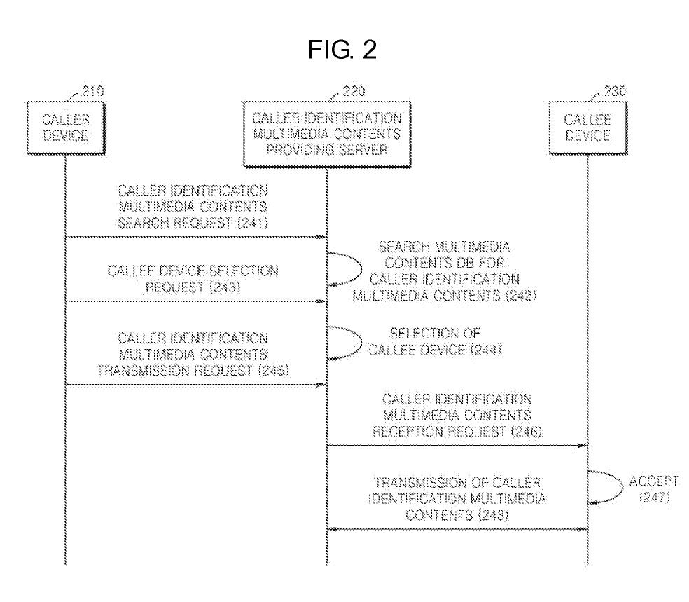

FIG. 2 illustrates a method of transmitting caller identification multimedia contents to a callee device 230, according to an embodiment of the present invention.

A caller device 210 may be connected to a caller identification multimedia contents providing server 220 by using an application for providing a caller identification multimedia contents configuring service or by using the WAP or WWW interface implemented in the caller identification multimedia contents providing server 220. The caller device 210 performs, using the application, the WAP interface, the WWW interface, or any other communication protocol, a caller identification multimedia contents search request (operation 241), a callee device selection request (operation 243), and a caller identification multimedia contents transmission request (operation 245) with respect to the caller identification multimedia contents providing server 220. According to the present embodiment, a dedicated application, the WAP interface, the WWW interface, or any other communication protocol is used to connect the caller device 210 to the caller identification multimedia contents providing server 220. However, any other connecting method may be used to connect the caller device 210 to the caller identification multimedia contents providing server 220.

The application for providing a caller identification multimedia contents configuring service may be downloaded from the caller identification multimedia contents providing server 220 or may be implemented into software embedded in the caller device 210.

In operation 241, the caller device 210 requests the caller identification multimedia contents providing server 220 to search for caller identification multimedia contents.

In operation 242, the caller identification multimedia contents providing server 220 searches a predetermined multimedia contents database for the caller identification multimedia contents at the request of the caller device 210.

The caller identification multimedia contents providing server 220 manages the caller identification multimedia contents in the form of a database. The database may be configured of at least one record including caller names, the number of the caller device, multimedia contents types, respective index values corresponding to the multimedia contents types, respective multimedia contents names corresponding to the multimedia contents types, respective file names corresponding to the multimedia contents types, and respective file sizes corresponding to the multimedia contents types.

The record may be implemented in the format of an electronic business card based on a vCard or wCard standard. The vCard standard defines the format of an electronic business card, and was developed by the Versit Consortium established by Apple Computer, AT&T, IBM, and Siemens and has been managed by the Internet Mail Consortium (IMC) since 1996. The wCard standard denotes an extension of the vCard standard according to mobile environments. The vCard and wCard standards are well known, so a description thereof will be omitted.

According to the present embodiment, the record of the database is configured as described above and implemented in the format of an electronic business card based on the vCard or wCard standard. However, other record configuring methods and other record implementing methods may be used, or a file system other than the database may be used.

In operation 243, the caller device 210 requests the caller identification multimedia contents providing server 220 to select the callee device 230 which is to receive the caller identification multimedia contents.

In operation 244, the caller identification multimedia contents providing server 220 selects the callee device 230.

In operation 245, the caller device 210 requests the caller identification multimedia contents providing server 220 to transmit the caller identification multimedia contents to the callee device 230.

In operation 246, the caller identification multimedia contents providing server 220 requests the callee device 230 to receive the caller identification multimedia contents. The caller identification multimedia contents providing server 220 may use the WAP PUSH method including the ID of an application for providing a caller identification multimedia contents configuring service or the general SMS transmission method including a callback URL in order to request the callee device 230 to receive the caller identification multimedia contents. However, other requesting methods or other requesting protocols may be used.

If the callee device 230 accepts the request to receive the caller identification multimedia contents in operation 247, the caller identification multimedia contents providing server 220 transmits the caller identification multimedia contents to the callee device 230 in operation 248.

The callee device 230 may receive the caller identification multimedia contents from the caller identification multimedia contents providing server 220 by using a callback URL included in a general SMS message. Alternatively, the callee device 230 may receive the caller identification multimedia contents from the caller identification multimedia contents providing server 220 by using an application that is identified by an application ID included in a WAP PUSH message and activated.

Although it is stated that the callee device 230 may use an application identified using a WAP PUSH method or a callback URL received using a general SMS transmission method in order to receive the caller identification multimedia contents from the caller identification multimedia contents providing server 220, other receiving methods or other receiving protocols may be used.

Although not shown in FIG. 2, if the callee device 230 refuses the request to receive the caller identification multimedia contents, the caller identification multimedia contents providing server 220 is notified of the refusal to receive the caller identification multimedia contents.

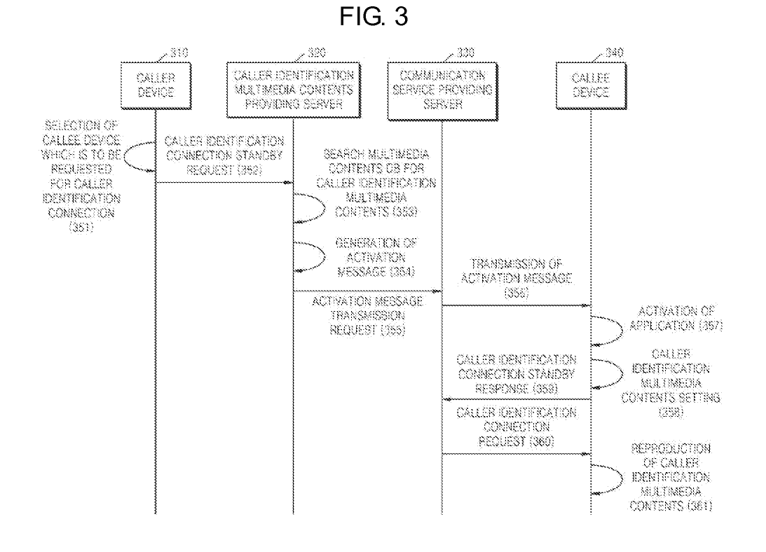

FIG. 3 illustrates a method of configuring caller identification multimedia contents in a callee device 340, according to an embodiment of the present invention.

In operation 351, a caller device 310 selects the callee device 340 which is to be requested for a caller identification connection, in order to perform the caller identification connection on the callee device 340. The caller device 310 may select the callee device 340 by using an application for providing a caller identification multimedia contents configuring service. Alternatively, the caller device 310 may be connected to a caller identification multimedia contents providing server 320 through the WAP interface, the WWW interface, or any other communication protocol in order to select the callee device 340.

According to the present embodiment, the caller device 310 uses a dedicated application, the WAP interface, the WWW interface, or any other communication protocol in order to select the callee device 340. However, other selecting methods may be used.

In operation 352, the caller device 310 requests the caller identification multimedia contents providing server 320 so that the selected callee device 340 sets the caller identification connection on standby.

In operation 353, the caller identification multimedia contents providing server 320 searches the multimedia contents database for caller identification multimedia contents corresponding to the caller device 310.

In operation 354, the caller identification multimedia contents providing server 320 generates an activation message including the ID of the caller identification multimedia contents and the ID of an application for providing a caller identification multimedia contents configuring service.

In operation 355, the caller identification multimedia contents providing server 320 requests a communication service providing server 330 to transmit the activation message to the callee device 340.

In operation 356, the communication service providing server 330 transmits the activation message to the callee device 340.

In operation 357, the callee device 340 activates the application by using the activation message including the ID of the caller identification multimedia contents and the ID of an application for providing a caller identification multimedia contents configuring service.

In operation 358, the callee device 340 sets caller identification multimedia contents corresponding to the ID of the caller identification multimedia contents to be a basic ring tone. In this case, the callee device 340 may back up the original basic ring tone, and then restore the original basic ring tone when the caller identification connection has concluded.

In operation 359, the callee device 340 transmits a caller identification connection standby response to the communication service providing server 330. The caller identification connection standby response indicates the state that the application activation and basic ring tone setting were properly performed.

In operation 360, the callee device 340 receives a caller identification connection request from the communication service providing server 330. Thereafter, in operation 361, the callee device 340 reproduces the caller identification multimedia contents.

According to another embodiment of the present invention, the communication service providing server 330 may forward the caller identification connection standby response to the caller identification multimedia contents providing server 320. The caller identification multimedia contents providing server 320 may transmit the caller identification connection request to the communication service providing server 330. After receiving the caller identification connection request from the communication service providing server 330, the callee device 340 may reproduce the caller identification multimedia contents.

According to another embodiment of the present invention, the caller identification multimedia contents providing server 320 may forward the caller identification connection standby response received from the communication service providing server 330 to the caller device 310. The caller device 310 may transmit the caller identification connection request to the caller identification multimedia contents providing server 320. The caller identification multimedia contents providing server 320 may forward the caller identification connection request to the communication service providing server 330. The communication service providing server 330 may transmit the caller identification connection request to the callee device 340. In response to the caller identification connection request, the callee device 340 may reproduce the caller identification multimedia contents.

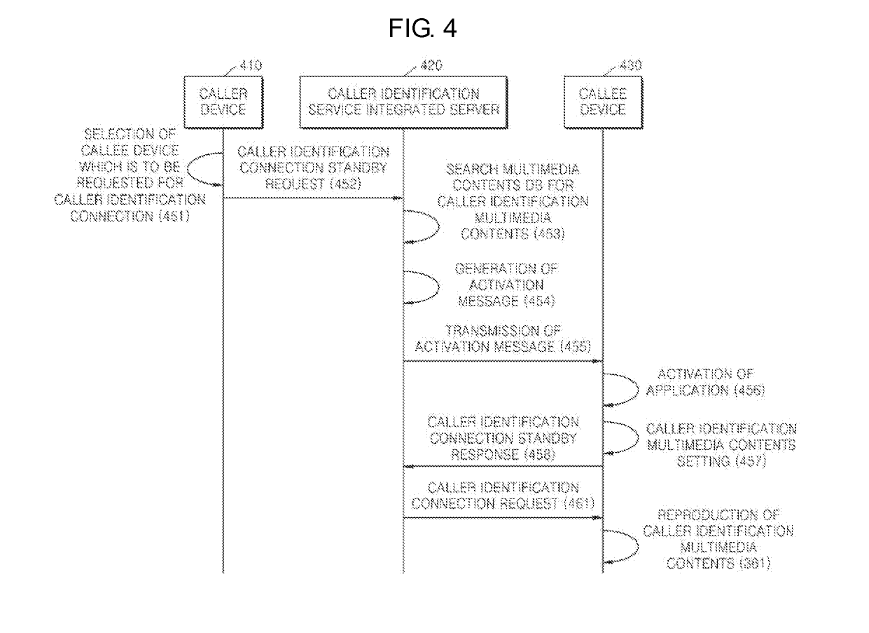

FIG. 4 illustrates a method of configuring caller identification multimedia contents in a callee device 430, according to another embodiment of the present invention.

According to the present embodiment, since the caller identification multimedia contents providing server 150 and the communication service providing server 160 may be integrally formed in one unit, the caller identification multimedia contents providing server 150 and the communication service providing server 160 are integrally formed into a caller identification service integrated server 420.

In operation 451, a caller device 410 selects the callee device 430 which is to be requested for a caller identification connection, in order to perform the caller identification connection on the callee device 430.

The caller device 410 may select the callee device 430 by using an application for providing a caller identification multimedia contents configuring service. Alternatively, the caller device 410 may be connected to the caller identification service integrated server 420 through the WAP interface, the WWW interface, or any other communication protocol in order to select the callee device 430.

According to the present embodiment, the caller device 410 uses a dedicated application, the WAP interface, the WWW interface, or any other communication protocol in order to select the callee device 430. However, other selecting methods may be used.

In operation 452, the caller device 410 requests the caller identification service integrated server 420 so that the selected callee device 430 sets the caller identification connection on standby.

In operation 453, the caller identification service integrated server 420 searches the multimedia contents database for caller identification multimedia contents corresponding to the caller device 410.

In operation 454, the caller identification service integrated server 420 generates an activation message including the ID of the caller identification multimedia contents and the ID of an application for providing a caller identification multimedia contents configuring service.

In operation 455, the caller identification service integrated server 420 transmits the activation message to the callee device 430.

In operation 456, the callee device 430 activates the application by using the activation message including the ID of the caller identification multimedia contents and the ID of an application for providing a caller identification multimedia contents configuring service.

In operation 457, the callee device 430 sets caller identification multimedia contents to be a basic ring tone. In this case, the callee device 430 may back up the original basic ring tone and then restore the original basic ring tone when the caller identification connection has concluded.

In operation 458, the callee device 430 transmits a caller identification connection standby response to the caller identification service integrated server 420. The caller identification connection standby response indicates the state that the application activation and the basic ring tone setting were properly performed.

In operation 461, the callee device 430 receives a caller identification connection request from the caller identification service integrated server 420.

In operation 462, the callee device 430 reproduces the caller identification multimedia contents.

According to another embodiment of the present invention, the caller identification service integrated server 420 may forward the caller identification connection standby response to the caller device 410. The caller device 410 may transmit the caller identification connection request to the caller identification service integrated server 420. After receiving the caller identification connection request from the caller identification service integrated server 420, the callee device 430 may reproduce the caller identification multimedia contents.

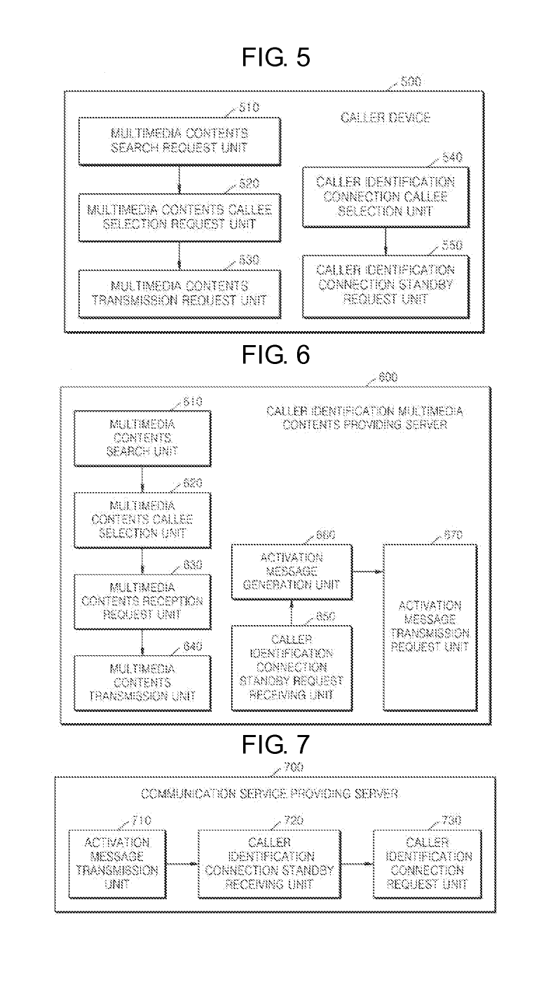

FIG. 5 is a diagram of a caller device 500 according to an embodiment of the present invention.

The caller device 500 includes a multimedia contents search request unit 510, a multimedia contents callee selection request unit 520, a multimedia contents transmission request unit 530, a caller identification connection callee selection unit 540, and a caller identification connection standby request unit 550.

The multimedia contents search request unit 510 requests a caller identification multimedia contents providing server 600 (see FIG. 6) for a caller identification multimedia contents search.

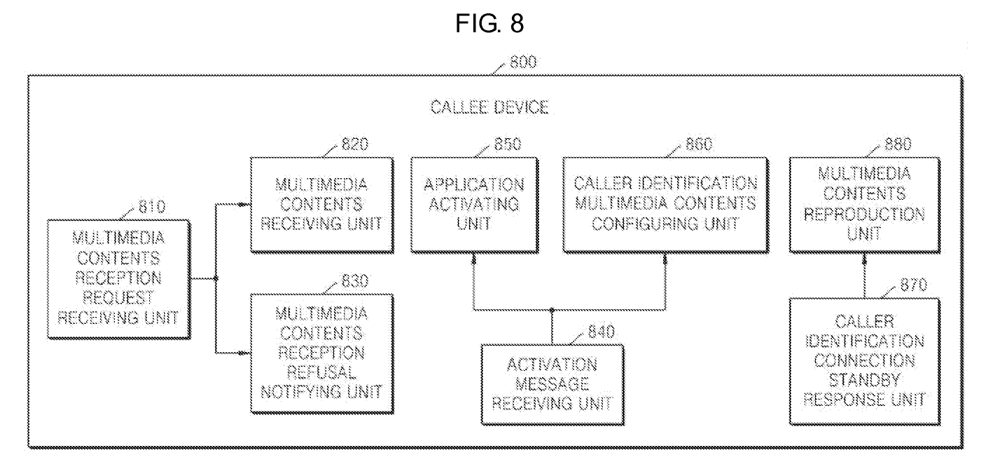

The multimedia contents callee selection request unit 520 requests the caller identification multimedia contents providing server 600 to select a callee device 800 (see FIG. 8) which is to receive caller identification multimedia contents.

The multimedia contents transmission request unit 530 requests the caller identification multimedia contents providing server 600 to transmit the caller identification multimedia contents to the callee device 800.

The multimedia contents search request unit 510, the multimedia contents callee selection request unit 520, and the multimedia contents transmission request unit 530 perform the caller identification multimedia contents search request (operation 241), the callee device selection request (operation 243), and the caller identification multimedia contents transmission request (operation 245), respectively, with respect to the caller identification multimedia contents providing server 600 by using an application for providing a caller identification multimedia contents configuring service or using the WAP interface, the WWW interface, or any other communication protocol implemented in the caller identification multimedia contents providing server 600. According to the present embodiment, a dedicated application, the WAP interface, the WWW interface, or any other communication protocol is used to connect the caller device 500 to the caller identification multimedia contents providing server 600. However, any other connecting method may be used to connect the caller device 500 to the caller identification multimedia contents providing server 600.

The application for providing a caller identification multimedia contents configuring service may be downloaded from the caller identification multimedia contents providing server 600 or may be implemented into software embedded in the caller device 500. The caller identification connection callee selection unit 540 selects the callee device 800 which is to be requested for a caller identification connection.

The caller identification connection standby request unit 550 requests the caller identification multimedia contents providing server 600 so that the callee device 800 sets the caller identification connection on standby.

The caller device 500 may further include a caller identification connection standby receiving unit (not shown) and a caller identification connection request unit (not shown).

The caller identification connection standby receiving unit may receive a caller identification connection standby response from the caller identification multimedia contents providing server 600. The caller identification connection standby response indicates the state that the caller identification multimedia contents have been configured in the callee device 800 and the application has been activated.

The caller identification connection request unit requests the caller identification multimedia contents providing server 600 for the caller identification connection.

FIG. 6 is a diagram of the caller identification multimedia contents providing server 600 according to an embodiment of the present invention.

The caller identification multimedia contents providing server 600 includes a multimedia contents search unit 610, a multimedia contents callee selection unit 620, a multimedia contents reception request unit 630, a multimedia contents transmission unit 640, a caller identification connection standby request receiving unit 650, an activation message generation unit 660, and an activation message transmission request unit 670.

The multimedia contents search unit 610 searches a predetermined multimedia contents database for the caller identification multimedia contents at the request of the caller device 500. The multimedia contents database may be configured of at least one record including caller names, the number of the caller device, multimedia contents types, respective index values corresponding to the multimedia contents types, respective multimedia contents names corresponding to the multimedia contents types, respective file names corresponding to the multimedia contents types, and respective file sizes corresponding to the multimedia contents types. The record may be implemented in the format of an electronic business card based on a vCard or wCard standard.

According to the present embodiment, the record of the database is configured as described above and implemented in the format of an electronic business card based on the vCard or wCard standard. However, other record configuring methods and other record implementing methods may be used, or a file system other than the database may be used.

The multimedia contents callee selection unit 620 selects the callee device 800 which is to receive the caller identification multimedia contents.

The multimedia contents reception request unit 630 requests the callee device 800 to receive the caller identification multimedia contents. The multimedia contents reception request unit 630 may use the WAP PUSH method including the ID of an application for providing a caller identification multimedia contents configuring service or the general SMS transmission method including a callback URL in order to request the callee device 800 to receive the caller identification multimedia contents. However, other requesting methods or other requesting protocols may be used.

If the callee device 800 accepts the request to receive the caller identification multimedia contents, the multimedia contents transmission unit 640 transmits the caller identification multimedia contents to the callee device 800.

The caller identification connection standby request receiving unit 650 receives a caller identification connection standby request for the callee device 800 from the caller device 500.

The activation message generation unit 660 generates an activation message including the ID of the caller identification multimedia contents found by the multimedia contents search unit 610 and the ID of an application for providing a caller identification multimedia contents configuring service.

The activation message transmission request unit 670 requests a communication service providing server 700 (see FIG. 7) to transmit the activation message to the callee device 800.

FIG. 7 is a diagram of the communication service providing server 700 according to an embodiment of the present invention.

The communication service providing server 700 includes an activation message transmission unit 710, a caller identification connection standby receiving unit 720, and a caller identification connection request unit 730.

The activation message transmission unit 710 transmits the activation message including the ID of the caller identification multimedia contents and the ID of the application for providing a caller identification multimedia contents configuring service to the callee device 800.

The caller identification connection standby receiving unit 720 receives a caller identification connection standby response from the callee device 800. The caller identification connection standby response indicates that the caller identification multimedia contents have been configured in the callee device 800 and the application has been activated.

The caller identification connection request unit 730 requests the callee device 800 for the caller identification connection.

FIG. 8 is a diagram of the callee device 800 according to an embodiment of the present invention.

The callee device 800 includes a multimedia contents reception request receiving unit 810, a multimedia contents receiving unit 820, a multimedia contents reception refusal notifying unit 830, an activation message receiving unit 840, an application activating unit 850, a caller identification multimedia contents configuring unit 860, a caller identification connection standby response unit 870, and a multimedia contents reproduction unit 880.

The multimedia contents reception request receiving unit 810 receives a caller identification multimedia contents reception request from the caller identification multimedia contents providing server 600.

If the callee device 800 accepts the caller identification multimedia contents reception request, the multimedia contents receiving unit 820 receives the caller identification multimedia contents from the caller identification multimedia contents providing server 600.

The multimedia contents receiving unit 820 may receive the caller identification multimedia contents from the caller identification multimedia contents providing server 600 by using a callback URL included in a general SMS message. Alternatively, the multimedia contents receiving unit 820 may receive the caller identification multimedia contents from the caller identification multimedia contents providing server 600 by using an application that is identified by an application ID included in a WAP PUSH message and activated.

Although it is stated that the multimedia contents receiving unit 820 may use an application identified using a WAP PUSH method or a callback URL received using a general SMS transmission method in order to receive the caller identification multimedia contents from the caller identification multimedia contents providing server 600, other receiving methods or other receiving protocols may be used.

If the callee device 800 refuses the request to receive the caller identification multimedia contents, the multimedia contents reception refusal notifying unit 830 notifies the caller identification multimedia contents providing server 600 of the refusal to receive the caller identification multimedia contents.

The activation message receiving unit 840 receives the activation message including the ID of the caller identification multimedia contents and the ID of the application for providing a caller identification multimedia contents configuring service from the communication service providing server 700.

The application activating unit 850 activates the application.

The caller identification multimedia contents configuring unit 860 sets the caller identification multimedia contents to be a basic ring tone.

The caller identification connection standby response unit 870 transmits a caller identification connection standby response to the communication service providing server 700. The caller identification connection standby response indicates the state that the application activation and the basic ring tone setting were properly performed.

If the multimedia contents reproduction unit 880 receives the caller identification connection request from the communication service providing server 700, the multimedia contents reproduction unit 880 reproduces the caller identification multimedia contents.

The callee device 800 may further include a backup unit (not shown) and a restoration unit (not shown). The backup unit backs up the original basic ring tone. The restoration unit restores the original basic ring tone when the caller identification connection has concluded.

While the present invention has been particularly shown and described with reference to exemplary embodiments thereof, it will be understood by those of ordinary skill in the art that various changes in form and details may be made therein without departing from the spirit and scope of the present invention as defined by the following claims.

For example, each of the caller device 500, the callee device 800, and the caller identification multimedia contents providing server 600 and the communication service providing server 700 may include a bus coupled to the component units illustrated in each of FIGS. 5, 8, 6, and 7, and at least one processor coupled to the bus. Each of the caller device 500, the callee device 800, and the caller identification multimedia contents providing server 600 and the communication service providing server 700 may also include a memory that is coupled to the bus to store commands, received messages, or generated messages and that is coupled to at least one processor for performing such commands as described above.

A system according to the present invention can also be embodied as computer readable code on a computer readable recording medium. The computer readable recording medium is any data storage device that can store data which can be thereafter read by a computer system. Examples of the computer readable recording medium include magnetic storage media (e.g., ROM, floppy disks, hard disks, etc.), optical recording media (e.g., CD-ROMs, or DVDs), and so on. The computer readable recording medium can also be distributed over network coupled computer systems so that the computer readable code is stored and executed in a distributed fashion.

1. A method performed in a caller device to configure caller identification multimedia contents, the method comprising:
requesting a caller identification multimedia contents providing server to search for the caller identification multimedia contents;
requesting the caller identification multimedia contents providing server to select a callee device which is to receive the caller identification multimedia contents; and
requesting the caller identification multimedia contents providing server to transmit the caller identification multimedia contents to the callee device.

2. The method of claim 1, wherein the search request, the selection request, and the caller identification multimedia contents transmission request are performed using an application for providing a caller identification multimedia contents configuring service.

3. The method of claim 2, wherein the application is downloaded from the caller identification multimedia contents providing server or implemented into software embedded in the caller device.

4. The method of claim 1, wherein the search request, the selection request, and the caller identification multimedia contents transmission request are performed using a Wireless Application Protocol (WAP) interface or a World Wide Web (WWW) interface which are implemented in the caller identification multimedia contents providing server.

5. The method of claim 1, further comprising:
selecting the callee device which is to be requested for a caller identification connection; and
requesting the caller identification multimedia contents providing server so that the callee device sets the caller identification connection on standby.

6. The method of claim 5, further comprising:
receiving a caller identification connection standby response from the caller identification multimedia contents providing server, wherein the caller identification connection standby response indicates that the caller identification multimedia contents have been configured in the callee device and the application has been activated; and requesting the caller identification multimedia contents providing server for the caller identification connection.

7. A method performed in a caller identification multimedia contents providing server to configure caller identification multimedia contents, the method comprising:
searching a predetermined multimedia contents database for the caller identification multimedia contents at a request of a caller device;
selecting a callee device which is to receive the caller identification multimedia contents;
requesting the callee device to receive the caller identification multimedia contents; and
if the callee device accepts the request to receive the caller identification multimedia contents, transmitting the caller identification multimedia contents to the callee device.

8. The method of claim 7, wherein the predetermined multimedia contents database is configured of at least one record comprising caller names, the number of the caller device, multimedia contents types, respective index values corresponding to the multimedia contents types, respective multimedia contents names corresponding to the multimedia contents types, respective file names corresponding to the multimedia contents types, and respective file sizes corresponding to the multimedia contents types.

9. The method of claim 8, wherein the record is implemented in the format of an electronic business card based on a vCard or wCard standard.

10. The method of claim 7, further comprising:
receiving a caller identification connection standby request for the callee device from the caller device;
searching the predetermined multimedia contents database for the caller identification multimedia contents corresponding to the caller device; and
generating an activation message comprising an identifier (ID) of the caller identification multimedia contents and an ID of an application for providing a caller identification multimedia contents configuring service.

11. The method of claim 10, further comprising requesting a communication service providing server to transmit the activation message to the callee device.

12. A method performed in a communication service providing server to configure caller identification multimedia contents, the method comprising:
transmitting an activation message comprising an ID of the caller identification multimedia contents and an ID of an application for providing a caller identification multimedia contents configuring service to a callee device;
receiving a caller identification connection standby response from the callee device, wherein the caller identification connection standby response indicates that the caller identification multimedia contents have been configured in the callee device and the application has been activated; and
requesting the callee device for a caller identification connection.

13. A method performed in a callee device to configure caller identification multimedia contents, the method comprising:
receiving a caller identification multimedia contents reception request from a caller identification multimedia contents providing server;
if the callee device accepts the caller identification multimedia contents reception request, receiving the caller identification multimedia contents from the caller identification multimedia contents providing server; and
if the callee device refuses the request to receive the caller identification multimedia contents, notifying the caller identification multimedia contents providing server of the refusal to receive the caller identification multimedia contents.

14. The method of claim 13, further comprising:
receiving an activation message comprising an ID of the caller identification multimedia contents and an ID of an application for providing a caller identification multimedia contents configuring service from a communication service providing server;
activating the application;
setting the caller identification multimedia contents to be a basic ring tone;
transmitting a caller identification connection standby response to the communication service providing server, wherein the caller identification connection standby response indicates the state that the application activation and the basic ring tone setting were properly performed; and
if the caller identification connection request is received from the communication service providing server, reproducing the caller identification multimedia contents.

15. The method of claim 14, further comprising:
backing up an original basic ring tone; and
restoring the original basic ring tone when the caller identification connection has concluded.

16. A caller device comprising:
a multimedia contents search request unit for requesting a caller identification multimedia contents providing server to search for the caller identification multimedia contents;
a multimedia contents callee selection request unit for requesting the caller identification multimedia contents providing server to select a callee device which is to receive the caller identification multimedia contents; and
a multimedia contents transmission request unit for requesting the caller identification multimedia contents providing server to transmit the caller identification multimedia contents to the callee device.

17. The caller device of claim 16, wherein the multimedia contents search request unit, the multimedia contents callee selection request unit, and the multimedia contents transmission request unit use an application for providing a caller identification multimedia contents configuring service.

18. The caller device of claim 17, wherein the application is downloaded from the caller identification multimedia contents providing server or implemented into software embedded in the caller device.

19. The caller device of claim 16, wherein the multimedia contents search request unit, the multimedia contents callee selection request unit, and the multimedia contents transmission request unit use a Wireless Application Protocol (WAP) interface or a World Wide Web (WWW) interface which are implemented in the caller identification multimedia contents providing server.

20. The caller device of claim 16, further comprising:
a caller identification connection callee selection unit for selecting the callee device which is to be requested for a caller identification connection; and
a caller identification connection standby request unit for requesting the caller identification multimedia contents providing server so that the callee device sets the caller identification connection on standby.

21. The caller device of claim 20, further comprising:
a caller identification connection standby receiving unit for receiving a caller identification connection standby response from the caller identification multimedia contents providing server, wherein the caller identification connection standby response indicates that the caller identification multimedia contents have been configured in the callee device and the application has been activated; and
a caller identification connection request unit for requesting the caller identification multimedia contents providing server for the caller identification connection.

22. A caller identification multimedia contents providing server comprising:
a multimedia contents search unit for searching a predetermined multimedia contents database for the caller identification multimedia contents at a request of a caller device;
a multimedia contents callee selection unit for selecting a callee device which is to receive the caller identification multimedia contents;
a multimedia contents reception request unit for requesting the callee device to receive the caller identification multimedia contents; and
a multimedia contents transmission unit, if the callee device accepts the request to receive the caller identification multimedia contents, for transmitting the caller identification multimedia contents to the callee device.

23. The caller identification multimedia contents providing server of claim 22, wherein the predetermined multimedia contents database is configured of at least one record comprising caller names, the number of the caller device, multimedia contents types, respective index values corresponding to the multimedia contents types, respective multimedia contents names corresponding to the multimedia contents types, respective file names corresponding to the multimedia contents types, and respective file sizes corresponding to the multimedia contents types.

24. The caller identification multimedia contents providing server of claim 23, wherein the record is implemented in the format of an electronic business card based on a vCard or wCard standard.

25. The caller identification multimedia contents providing server of claim 22, further comprising:
a caller identification connection standby request receiving unit for receiving a caller identification connection standby request for the callee device from the caller device; and
an activation message generation unit for generating an activation message, the activation message comprising an identifier (ID) of the caller identification multimedia contents found by the multimedia contents search unit and an ID of an application for providing a caller identification multimedia contents configuring service.

26. The caller identification multimedia contents providing server of claim 25, further comprising an activation message transmission request unit for requesting a communication service providing server to transmit the activation message to the callee device.

27. A communication service providing server comprising:
an activation message transmission unit for transmitting an activation message comprising an identifier (ID) of the caller identification multimedia contents and an ID of an application for providing a caller identification multimedia contents configuring service to a callee device;
a caller identification connection standby receiving unit for receiving a caller identification connection standby response from the callee device, wherein the caller identification connection standby response indicates that the caller identification multimedia contents have been configured in the callee device and the application has been activated; and
a caller identification connection request unit for requesting the callee device for a caller identification connection.

28. A callee device comprising:
a multimedia contents reception request receiving unit for receiving a caller identification multimedia contents reception request from a caller identification multimedia contents providing server;
a multimedia contents receiving unit, if the callee device accepts the caller identification multimedia contents reception request, for receiving the caller identification multimedia contents from the caller identification multimedia contents providing server; and
a multimedia contents reception refusal notifying unit, if the callee device refuses the request to receive the caller identification multimedia contents, for notifying the caller identification multimedia contents providing server of the refusal to receive the caller identification multimedia contents.

29. The callee device of claim 28, further comprising:
an activation message receiving unit for receiving an activation message comprising an identifier (ID) of the caller identification multimedia contents and an ID of an application for providing a caller identification multimedia contents configuring service from a communication service providing server;
an application activating unit for activating the application;
a caller identification multimedia contents configuring unit for setting the caller identification multimedia contents to be a basic ring tone;
a caller identification connection standby response unit for transmitting a caller identification connection standby response to the communication service providing server, wherein the caller identification connection standby response indicates the state that the application activation and the basic ring tone setting were properly performed; and
a multimedia contents reproduction unit, if the caller identification connection request is received from the communication service providing server, for reproducing the caller identification multimedia contents.

30. The callee device of claim 29, further comprising:
a backup unit for backing up an original basic ring tone; and
a restoration unit for restoring the original basic ring tone when the caller identification connection has concluded.

31. A computer readable recording medium having recorded thereon a program for executing the method of claim 1.

32. A computer readable recording medium having recorded thereon a program for executing the method of claim 7.

33. A computer readable recording medium having recorded thereon a program for executing the method of claim 12.

34. A computer readable recording medium having recorded thereon a program for executing the method of claim 13.
